(19) United States
(12) Patent Application Publication
(10) Pub. No.: US 2025/0203558 A1
(43) Pub. Date: Jun. 19, 2025

(54) METHODS FOR MANAGING POSITIONING RFERENCE SIGNAL TRANSMISSION BETWEEN A PLURALITY OF WIRELESS DEVICES, A RELATED POSITIONING NETWORK NODE AND A RELATED WIRELESS DEVICE

(71) Applicant: Sony Group Corporation, Tokyo (JP)

(72) Inventors: Basuki PRIYANTO, Lund (SE); Anders BERGGREN, Lund (SE); Yujie ZHANG, Lund (SE); Jose FLORDELIS, Lund (SE); Johan HILL, Lund (SE)

(21) Appl. No.: 18/847,233

(22) PCT Filed: Mar. 22, 2023
(86) PCT No.: PCT/EP2023/057380

§ 371 Date: Sep. 14, 2024

(30) Foreign Application Priority Data
Mar. 31, 2022 (SE) 2250407-0

(51) Int. Cl. H04W 64/00; H04L 5/00; H04W 72/12; H04W 92/18

(52) U.S. Cl. CPC H04W 64/00; H04L 5/0051; H04W 72/12; H04W 92/18

(57) ABSTRACT

A method is disclosed, performed by a positioning network node, for managing positioning reference signal transmission between a plurality of wireless devices. The method comprises obtaining information indicative of contextual information relating to a geographical area being served by the positioning network node. The method comprises initiating a transmission of a configuration message for sidelink positioning reference signal transmission based on the obtained contextual information. The configuration message comprises one or more of a resource scheduling and a transmission condition for transmitting a sidelink positioning reference signal.

The present disclosure pertains to the field of wireless communications. The present disclosure relates to a method for managing positioning reference signal transmission between a plurality of wireless devices, a related positioning network node and a related wireless device.

### BACKGROUND

Positioning is an important feature of the 3rd Generation Partnership Project (3GPP) Fifth Generation (5G) New Radio (NR), targeting high accuracy positioning of wireless devices. For positioning in NR sidelink positioning (such as using a PC5 interface) has been considered, in which Vehicle-to-everything (V2X) positioning is one of the primary use-cases. One of the scenarios that V2X seeks to handle is providing safety to Vulnerable Road Users (VRUs), such as pedestrians or other unprotected persons, in the presence of vehicle(s) that could move with high velocity. This can be handled by obtaining the positions of VRUs and Vehicles. In case the relative distance between VRUs and Vehicles is relatively close and there is a risk of physical collision between the VRU (such as a pedestrian) and the vehicle, then the VRU and/or the vehicle may be warned to avoid the physical collision.

However, the number of wireless devices in certain areas may vary a lot depending on the situation, such as depending on a time of day, and the radio resources for sidelink transmission are limited. Hence, a VRU or a vehicle may not be able to perform a positioning measurement or receive a warning due to lack of available resources.

### SUMMARY

Accordingly, there is a need for devices and methods for managing positioning reference signal transmission between a plurality of wireless devices, which may mitigate, alleviate or address the shortcomings existing and may provide an improved utilization of radio resources.

A method is disclosed, performed by a positioning network node, for managing positioning reference signal transmission between a plurality of wireless devices. The method comprises obtaining information indicative of contextual information relating to a geographical area being served by the positioning network node. The method comprises initiating a transmission of a configuration message for sidelink positioning reference signal transmission based on the obtained contextual information. The configuration message comprises one or more of a resource scheduling and a transmission condition for transmitting a sidelink positioning reference signal.

Further, a positioning network node is provided, the positioning network node comprising memory circuitry, processor circuitry, and a wireless interface, wherein the positioning network node is configured to perform any of the methods disclosed herein and relating to the positioning network node.

By obtaining contextual information relating to the geographical area being served by the positioning network node and initiating a transmission of a configuration message comprising a resource scheduling and transmission conditions for transmitting sidelink positioning reference signals based on the contextual information, the positioning network node can adapt the resource scheduling and the transmission of sidelink positioning reference signals to current conditions, such as to a density of wireless devices, in the geographical area. The positioning network node can thereby restrict a first type of wireless devices from transmitting while allowing a second type of wireless devices to transmit sidelink positioning reference signals during certain conditions, such as density conditions, such as when the geographical area is crowded. By restricting a first type of wireless devices from transmitting, for example when the number of the first type of wireless devices is above a threshold, and instead configuring the first type of wireless devices to measure on sidelink positioning reference signals transmitted from a second type of wireless devices being less in number than the first type of wireless devices, the signaling in the predetermined area may be reduced while still allowing a positioning of the first type of wireless devices to be performed. Since the radio resources are limited and may be used by a plurality of wireless devices for various purposes, this can ensure that there are sufficient resources available in the predetermined area for transmissions related to sidelink positioning of the wireless devices, which ensures a timely determination of the wireless devices locations and a determination of a potential radio resource collision and/or congestion between wireless devices in the predetermined area. A radio resource collision may herein mean that a plurality of wireless devices transmit using the same radio resource, such as the same time and frequency. Thereby a warning can be sent to one or more of the wireless devices prior to a physical collision, such as a collision between a vehicle and a pedestrian, occurring, to avoid the physical collision. Furthermore, by scheduling the resources such that the number of wireless devices simultaneously transmitting is reduced, radio resource collision and/or interference between the transmitted positioning reference signals can be reduced. This may reduce the latency in the communication system and provide for a more accurate positioning of the wireless devices.

A method is disclosed, performed by a wireless device, for managing side-link communication between a plurality of wireless devices. The method comprises receiving, from a network node, a configuration message, the configuration message comprising a resource scheduling for transmitting sidelink positioning reference signals and a transmission condition for transmitting sidelink positioning reference signals according to the resource scheduling. The method comprises communicating, based on the received configuration message, a sidelink positioning reference signal in sidelink.

Further, a wireless device is disclosed, the wireless device comprising memory circuitry, processor circuitry, and a wireless interface, wherein the wireless device is configured to perform any of the methods disclosed herein and relating to the wireless device.

It is an advantage of the present disclosure that a resource scheduling and transmission conditions for transmitting sidelink positioning reference signals for the wireless device can be adapted based on a contextual information, for example, relating to a geographical area of the wireless device. The wireless device can be configured to transmit sidelink positioning reference signals according to current conditions, such as a density of wireless devices, in the geographical area of the wireless device. The wireless device can thereby be restricted from transmitting sidelink positioning reference signals during certain conditions, such as when the geographical area is crowded. By restricting a first type of wireless devices from transmitting and allowing a second type of wireless devices for transmitting, for example when the number of the first type of wireless devices is above a threshold, and instead configuring the first type of wireless devices to receive and to measure on sidelink positioning reference signals transmitted from a second type of wireless devices being less in number than the first type of wireless devices, the signalling in the predetermined area may be reduced while still allowing a positioning of the first type of wireless devices to be performed. Since the radio resources are limited and may be used by a plurality of wireless devices for various purposes, this can ensure that there are sufficient resources available in the predetermined area for transmissions related to sidelink positioning of the wireless devices, which ensures a timely determination of the wireless devices locations and a determination of a potential radio resource collision and/or congestion between wireless devices in the predetermined area. Thereby a warning message can be sent to one or more of the wireless devices prior to a physical collision such as a collision between a vehicle and a pedestrian, occurring, to avoid the physical collision. Furthermore, by scheduling the resources for transmission of sidelink positioning reference signals, such that the number of wireless devices simultaneously transmitting is reduced, radio resource collision and/or interference between the transmitted positioning reference signals can be reduced. This may reduce the latency in the communication system, improve the signal to noise and interference ratio, and provide for a more accurate positioning of the wireless device.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example radio network node, an example core network node and a plurality of example wireless devices according to this disclosure,

FIG. 2A-2B are diagrams illustrating example scenarios in which sidelink positioning may be used to avoid physical collisions between two wireless devices according to this disclosure,

FIG. 3 is a diagram illustrating an example scenario in which the solution according to this disclosure may be used,

FIG. 4 is a flow chart illustrating an example method, performed by a positioning network node, for managing positioning reference signal transmission between a plurality of wireless devices according to this disclosure,

FIG. 5 is a flow chart illustrating an example method, performed by a wireless device, for handling side-link communication between a plurality of WDs according to this disclosure,

FIG. 6 is a block diagram illustrating an example positioning network node according to this disclosure, and

FIG. 7 is a block diagram illustrating an example wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

A connected mode may refer to an operation mode wherein a data transmission may take place e.g. between the wireless device and a network node or between the wireless device and another wireless device. A connected mode may be referred to an operation state wherein a radio transmitter and/or a radio receiver is activated for such communication. A connected mode may refer to an operation state wherein the wireless device is synchronized time-wise and/or frequency-wise e.g. by a determined timing advance parameter for the communication.

In certain communication systems, a connected mode may refer to a radio resource control (RRC) state. In various examples, an active state may be a RRC connected state and/or an RRC active state.

A dormant mode is a mode where the wireless device has no active connection with the network node. A dormant mode may be seen as an inactive mode of the wireless device. A dormant mode may be seen as a mode where the wireless device is unsynchronized with a timing of a network or loosely synchronized. In one or many examples the wireless device may in a dormant mode not have a valid timing advance information with respect to the network. A dormant mode may be seen as a mode where the wireless device is unable to receive dedicated signaling. A dormant mode may be seen as a mode where closed loop power control is inactivated or suspended. Dormant mode may comprise RRC idle mode, RRC suspend and/or RRC inactive mode. For example, the wireless device may be in dormant mode when the connection with the network node has been released and/or suspended. A wireless device in dormant mode may need to get synchronized and perform cell reselection measurements and paging reception. If the wireless device is not being paged then the wireless device continues to stay in dormant mode.

The figures are schematic and simplified for clarity, and they merely show details which aid understanding the disclosure, while other details have been left out. Throughout, the same reference numerals are used for identical or corresponding parts.

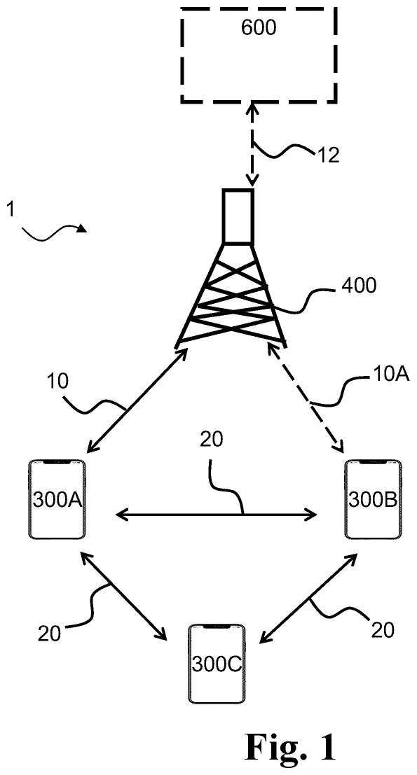

FIG. 1 is a diagram illustrating an example wireless communication system 1 comprising an example radio network node 400, an example core network node 600, an example first wireless device (WD) 300A, an example second WD 300B and an example third WD 3000 according to this disclosure. The first wireless device 300A, the second wireless device 300B and the third wireless device 3000 may be different types of wireless devices, such as a Vulnerable Road User (VRU) WD, a Road Side Unit (RSU) WD and a vehicle WD. In one or more example methods, the first wireless device 300A is a VRU WD, the second wireless device 300B is a RSU WD and the third wireless device 3000 is a vehicle WD. As discussed in detail herein, the present disclosure relates to a wireless communication system 1 comprising a cellular system, for example, a 3GPP wireless communication system.

A radio network node disclosed herein refers to a radio access network node operating in the radio access network, such as a base station, an evolved Node B, eNB, gNB in NR. In one or more examples, the RAN node is a functional unit which may be distributed in several physical units. A radio network node has at least one transmission and reception point (TRP) for the communication with the wireless device(s).

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME and/or a Location Management Function (LMF).

In one or more examples, the CN node is a functional unit which may be distributed in several physical units.

The wireless communication system 1 described herein may comprise one or more wireless devices 300A, 300B, 3000 and/or one or more radio network nodes 400, such as one or more of: a base station, an eNB, a gNB and/or an access point.

A WD may refer to a mobile device and/or a user equipment (UE).

The wireless device 300A, 300B, 3000 may be configured to communicate with the network node 400 via a wireless link (or radio access link) 10, 10A.

The core network node 600 may be configured to communicate with the radio network node 400 via a link 12, such as a wired and/or wireless link, and/or with the one or more wireless devices 300, 300A, via the radio network node 400.

The wireless devices 300A, 300B, 3000 may be configured to communicate directly with each other via a sidelink 20, such as without communicating via the radio network node 400. The sidelink 20 may be a wireless link, such as via a PC5 interface.

Positioning of wireless devices with high accuracy and low latency has been introduced in 3GPP Rel-17. These positioning measurements are based on communication over a Uu-interface, such as signaling between a radio network node, such as a gNB, and a wireless device, such as a UE. The positioning may be based on positioning reference signals transmitted in an Uplink (UL) and/or downlink (DL). DL transmissions herein refers to transmissions from the radio network node to the wireless device. UL transmissions herein refers to transmissions from the wireless device to the radio network node. Positioning measurements using sidelink signaling, such as positioning estimation utilizing a PC-5 interface, such as using signalling between wireless devices, is targeted to be part of 3GPP Rel-18. The PC-5 interface was introduced in LTE sidelink to enable device-to-device (D2D) communication, such as direct communication between a first wireless device and a second wireless device. In NR sidelink communication may be used for public safety purposes and Vehicle to Everything (V2X) communication. The NR sidelink protocol for communication is well established. However, positioning utilizing sidelink communication has not been defined in 3GPP.

A study item on expanded and improved NR positioning (RP-213588) has been agreed by 3GPP. One of the objectives is to study solutions for sidelink positioning considering V2X, public safety, commercial, and Industrial Internet-of-Things (IIoT) use-cases. The study also includes to evaluate performance and feasibility of potential solutions for sidelink positioning, considering relative positioning, ranging and absolute positioning.

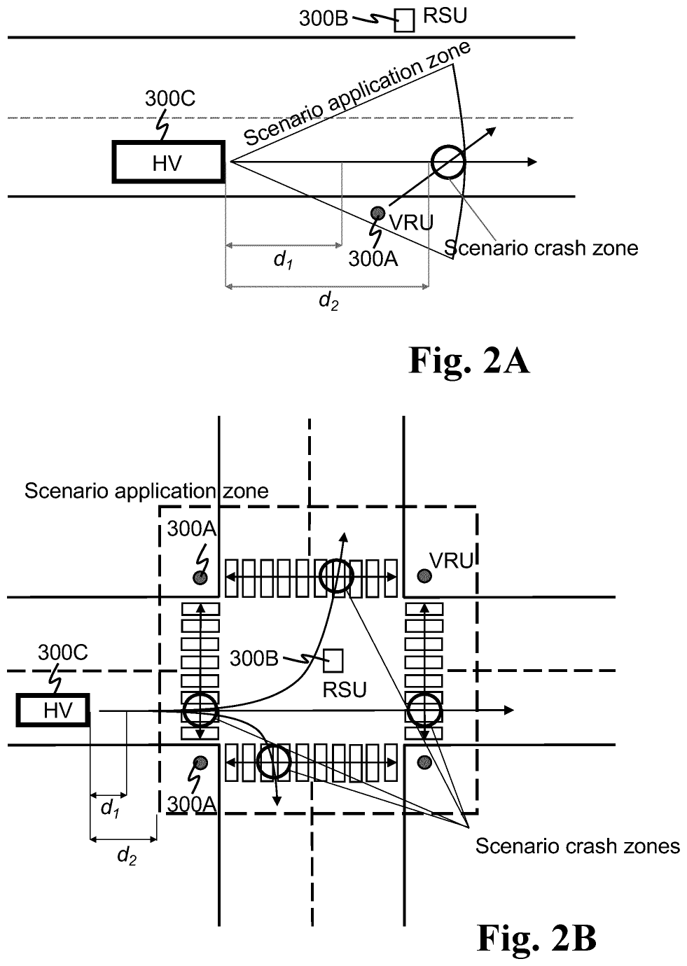

One of the challenging scenarios for positioning in V2X use-cases is to handle Vulnerable Road Users (VRUs), such as pedestrians, bikers, skaters, moving in the vicinity of vehicles and/or in areas populated by vehicles, such as in a scenario shown in FIG. 2A-2B.

FIG. 2A-2B show two different scenarios where there is a risk of a physical collision between a vehicle 3000 and a VRU 300A. A physical collision herein means for example a physical collision between the vehicle 3000 and the VRU 300A, such as with an unprotected person, such as a pedestrian, a biker, a skater, or similar. In the scenarios shown in FIG. 2B-2B sidelink positioning may be used to alert a vehicle 3000 of VRUs 300A approaching a road that the vehicle 3000 is travelling on, such as shown in FIG. 2A, and/or of VRUs 300A crossing an intersection which the vehicle 3000 is approaching, such as shown in FIG. 2B, and to warn of any risk of physical collision. In one or more example methods, to provide safety, typically on the road and/or in the intersection, there may be a RSU wireless device 300B. The RSU 300B may be a static wireless device having a fixed known position. The RSU 300B may in one or more example methods be integrated in a road sign, a street lighting, or in a traffic light. In the V2X context, the vehicle 3000, the VRU 300A and the RSU 300B may be equipped with respective communication modules, such as transceivers, that can support communication both via the Uu interface and via the PC5 interface. In order to avoid a physical collision between the vehicle 3000 and the VRU 300A in the scenarios shown in FIG. 2A and/or 2B, a position estimate of the VRU 300A and the vehicle 3000 is required. In one or more example methods, the RSU 300B, which has a fixed known position, can be used to assist in the positioning estimate of the VRU 300A and the vehicle 3000. In sidelink positioning, it is expected that one of the wireless devices transmits sidelink reference signals, such as sidelink positioning reference signals (SL-PRS). Other receiving wireless devices may perform a positioning measurement on the received SL-PRSs to estimate its own position or the position of the wireless device transmitting the SL-PRS. If the wireless device performs positioning estimation by itself, such as to determine its own position, the wireless device may not transmit a positioning measurement report. The position estimate can be in the form of a relative position (such as a distance between two WDs), range, or an absolute position (such as a geographical position). However, the radio resources to facilitate the afore-mentioned transmissions (such as for reference signal transmission, such as for SL-PRS transmissions) are limited. Furthermore, in order to avoid a physical collision, positioning measurements and positioning estimations must be performed in a timely manner, such as before a physical collision occurs, to have time to warn for example the VRU 300A or the vehicle 3000 of a potential physical collision. In FIGS. 2A and 2B the distance d1 corresponds to a stopping distance of the vehicle 3000 and the distance d2 corresponds to a distance from the vehicle 3000 to a scenario crash zone with the VRU 300A. A determination of the position of the VRU 300A and/or the vehicle 3000 and a transmission of a warning to the VRU 300A and/or the vehicle 3000 should therefore be performed before the distance d2 is equal to or smaller than the stopping distance d1 at what point a physical collision can no longer be avoided. Hence, the transmission may, in some cases, require low latency and high accuracy.

Furthermore, a distribution of wireless devices in a specific area, such as in a predetermined geographical area may vary significantly over time. At one particular time, such as during rush hour, there may be many wireless devices, such as several hundreds of wireless devices, in the specific area, while at a second particular time, such as at midnight, there may only be a few wireless devices in the specific area. During rush hour the radio resources may not be sufficient to allow all wireless devices in the specific area to transmit reference signals, such as SL-PRS, which could lead to high latency or some wireless devices not being able to transmit at all. The limited radio resources may also lead to the case of radio resource collision, which could occur when many wireless devices transmit at the same time. Radio resource collision leads to increasing signal to interference ratio, which makes that signals cannot be decoded by the receiver. This could lead to the position of some wireless devices not being determined in a timely manner, such as before a physical collision occurs, which may thus not be warned about a potential upcoming physical collision.

The current disclosure thus provides a mechanism for managing resource allocation, such as for managing a resource scheduling, to be used for a transmission related to sidelink positioning. A resource scheduling may herein be seen as a schedule of radio resources, such as time and frequency resources, assigned to one or more wireless devices for transmissions. The transmissions may be transmissions related to sidelink positioning, such as transmissions of SL-PRS. The resource scheduling may comprise one or more of an allocation of time and frequency resources and a periodicity of the allocated time and frequency resources. The resource scheduling may be assigned to an individual wireless device or to a plurality of wireless devices, such as to a group of wireless devices. The resource scheduling may, in one or more example methods, comprise an indication indicative of whether one or more wireless devices is allowed or not to transmit or receive in specific resource, such as an access grant.

In one or more example methods, usage of the scheduled resources may further be constrained by one or more transmission conditions. The one or more transmission conditions may indicate conditions, such as rules for when the wireless device is allowed to use the scheduled resources, such as the resources indicate in the resource scheduling, for transmitting transmissions related to sidelink positioning, such as SL-PRS.

The transmission related to sidelink-positioning may be one or more of a reference signal transmission (such as a sidelink positioning reference signal (PRS)), a positioning measurement report, and a positioning estimate. In one or more example methods, the positioning estimate comprises warning related information (for example, that there is a nearby wireless device, such as a vulnerable road user). The SL-PRS transmissions may be PRS transmissions by a RSU, a VRU, and/or a vehicle. The SL-PRS transmissions may be broadcasted, or dedicated (UE-specific) from a wireless device to at least one wireless device.

In one or more example methods, managing of the resource allocation can be done by the communications network, such as by a positioning network node. The positioning network node may be a core network node and/or a radio network node. Managing the resource allocation may comprise one or more of:
managing whether a wireless device can transmit and/or use the resources,
managing a frequency and/or periodicity of the transmission, and
managing a resource allocation location, such as a frequency and/or a time allocation of the transmission.

In one or more example methods, the resource scheduling, such as for transmission of sidelink positioning, is based on one or a combination of conditions.

In one or more example methods, the resource scheduling, such as for transmission of sidelink reference signals, is based on a type of the wireless device. According to the current disclosure, for sidelink positioning purposes, the wireless devices can be divided into the following three types of WDs: RSU WD, VRU WD, and Vehicle. The RSU may be a static WD, such as a WD having a static, such as a fixed, location and/or orientation. The VRU may be a non-static WD, such as a WD with a non-static, such as a non-fixed, location. Which type of WD a specific WD corresponds to may be determined based on a speed and/or location of the WD. For example, a WD moving along a road at a speed equal to or above a speed threshold may be determined to be a vehicle. A WD moving across a road, along a road and/or outside a road at a speed lower than the speed threshold may be determined to be a non-static WD, such as a VRU. A WD not moving may be determined to be a static WD, such as an RSU.

In one or more example methods, the different types of WDs can be allocated to use different resources for sidelink transmission, such as having different frequency and timing (periodicity).

In one or more example methods, the resource allocation is based on contextual information relating to a geographical area being served by the positioning network node. The contextual information may be seen as a set of information associated with a geographical area, that may be advantageous and/or necessary for determining a context of the geographical area. For example, the context may be indicative of a communication environment for wireless devices located in the geographical area, such as whether the geographical area is crowded or empty, and/or if there are many or a few wireless devices sharing the radio resources in the geographical area. The contextual information relating to a geographical area may be used to determine a resource allocation, such as one or more resource allocations, for wireless devices located in the geographical area.

The contextual information may comprise a density of WDs, such as non-static WDs, static WDs, and/or vehicles, in a predetermined geographical area. The density may herein mean the number of WDs in a predetermined geographical area. In one or more example methods, the contextual information comprises, such as comprises information indicative of, a number of wireless devices in the geographical area. The number of wireless devices may be indicated as an actual number of wireless devices or may be implicitly indicated, such as for example whether there are many wireless devices, a few wireless devices, or no wireless devices in the geographical area.

In one or more example methods, the contextual information comprises, such as comprises information indicative of, one or more types and/or groups of the wireless devices in the geographical area. The contextual information may for example indicate that there are one or more of a non-static wireless device, a static wireless device and a vehicle present in the geographical area.

In one or more example methods, the contextual information comprises, such as comprises information indicative of, a distribution of the types and/or groups of wireless devices in the geographical area. The distribution of the types and/or groups of wireless devices may for example indicate a number of a certain type of and/or groups of wireless devices in a specific region, zone and/or sub-zone.

In one or more example methods, the contextual information comprises, such as comprises information indicative of, a location of the wireless devices in the geographical area. The location may in one or more example methods, be indicated as one or more of an actual position (such as a coordinate of the wireless device), a region, a zone and/or a subzone in which the wireless device is located.

In one or more example methods, the contextual information comprises, such as comprises information indicative of, environmental information associated with the geographical area. The environmental data may comprise one or more of a time of day, weather information, and temperature of the geographical area.

The geographical area may be one or more of a region, a zone and a sub-zone. A region may be divided into a plurality of zones and a zone may be divided into a plurality of sub-zones. In one or more example methods, the contextual information comprises an identifier of the geographical area.

In one or more example methods, the resource scheduling, such as for sidelink reference signal transmission, is based on the distribution of non-static WDs, such as VRUs, presence (such as a density of VRUs) in a certain area, such as in a predetermined geographical area. Therefore, the network, such as a positioning network node, may obtain a distribution of WDs, such as the distribution of non-static WDs, such as VRUs, in the predetermined geographical area.

In one or more example methods, such as in a heavy non-static WD presence condition, such as when the number of non-static WDs, such as VRUs, in the predetermined geographical area is equal to or above a presence threshold, the resource scheduling comprises one or more of:
only static WDs, such as RSUs, being scheduled to transmit, and non-static WDs, such as VRUs, being scheduled not to transmit, and
static WDs, such as RSUs, transmitting frequently, and non-static WDs, such as VRUs, transmitting less frequently and/or only selected non-static WDs transmitting.

In one or more example methods, such as in a low non-static WD presence condition, such as when the number of non-static WDs, such as VRUs, in the predetermined geographical area is below the presence threshold, the resource scheduling comprises one or more of:
only non-static WDs, such as VRUs, being scheduled to transmit, and
non-static WDs, such as VRUs, transmitting frequently, and static WDs, such as RSUs transmitting less frequently and/or only selected static WDs transmitting.

In one or more example methods, the network, such as the positioning network node, may determine one or more transmission condition(s) for transmission of SL-PRS. In one or more example methods, the transmission condition indicates conditions, such as rules for when the wireless device is allowed to use the scheduled resources, such as the resources indicate in the resource scheduling, for transmitting transmissions related to sidelink positioning, such as SL-PRS. The transmission condition may be provided to the wireless devices by a radio network node, such as by a gNB, via the Uu interface. The radio network node may thus, in one or more example methods, control the transmission of SL-PRS. This may for example apply to sidelink communication with mode 1. Sidelink communication with mode 1 herein means that a radio network node through the Uu interface allocates resources for sidelink communication between wireless devices via the PC5 interface. In mode 2 sidelink communication the WDs may allocate sidelink PC5 resources on their own. Mode 2 sidelink communication may for example be used when the WDs are out of coverage from a radio network node. In one or more example methods, the network may determine and/or control which WD or group of WDs that is allowed to transmit SL-PRS. In one or more example methods, the network may determine and/or control an activation and/or deactivation of when a WD and/or a group of WDs can transmit SL-PRS. In one or more example methods, the group of WDs can be classified as one or more of WDs having a specific WD ID (such as UE ID), WDs being of a specific WD type (such as RSU, VRU or vehicle), and WDs having a same zone ID and/or sub-zone ID.

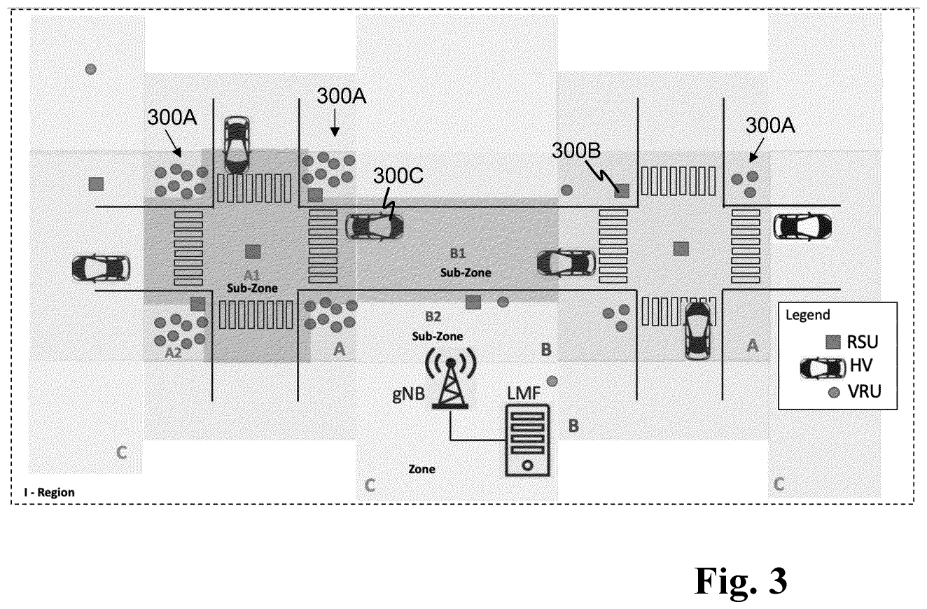

In one or more example methods, the resource scheduling, such as the transmission of SL-PRS, is based on the location of the WDs. In one or more example methods, a WD (such as a non-static WD and/or a Vehicle) can transmit, such as SL-PRS transmissions, more frequently in some predefined geographical areas than in others, such as in certain regions and/or locations than in other regions and/or locations. For example, a location and/or area along a road may be divided into multiple regions. Each region may, in one or more example methods, comprise a number of zones and/or sub-zones. A region herein is representing a geographical area. The location and/or area may be a predefined location and/or area. For example, a first zone, herein referred to as Zone A, may represent a junction. A second zone, herein referred to as Zone B, may represent the road without a junction. A third zone, herein referred to as Zone C, may represent an area outside the road. In one or more example methods, a zone can consist of multiple sub-zones. In one or more example methods, a first subzone, such as for example a sub-zone A1 and/or B1, is a danger area. The sub-zone A1 and/or B1 may for example be the road itself, such as a pedestrian crossing on the road. A second sub-zone, such as a sub-zone A2 and/or B2 may, in one or more example methods, be an area next to the danger area. The zones and/or sub-zones will be described in further detail in FIG. 3.

FIG. 3 illustrates an example scenario in which the solution according to the current disclosure may be used. FIG. 3 discloses a region of a road as indicated by the dotted frame. The region may comprise and/or may be divided into one or more zone(s) and/or sub-zones. The zones and/or sub-zones may be classified based on a probability of a physical collision between a non-static wireless device and a vehicle, such as based on a probability that a non-static wireless device enters the road of the vehicle. In one or more example methods, the zones can be classified into a high alert zone (Zone A), an alert zone (Zone B), and a safe zone (Zone C). In the high alert zone the probability that a non-static wireless device enters the road is higher than in the alert zone or in the safe zone. In the alert zone there is still a risk of a physical collision due to a non-static wireless device enters the road but is lower than in the high alert zone. In the safe zone there is a low risk, such as a lower risk than in the high alert zone and the alert zone, that a non-static wireless device enters the road. Each zone may be divided into one or more sub-zones, such as danger sub-zone (A1, B1), and/or a semi-danger sub-zone (A2, B2). Based on the type of geographical area, such as based on whether the wireless device is located in zone A, B, or C, and/or in subzone A1, A2, B1 or B2, the transmit periodicity (for example for transmitting SL-PRS) can vary. For example, the transmission periodicity in sub-zone A1 may be smaller than the transmission periodicity in sub-zone A2. In this case, a wireless device in sub-zone A1 may be configured to transmit SL-PRS signals more frequent (such as at a smaller periodicity) than a wireless device in sub-zone A2. Thereby, the wireless device in the danger sub-zone of the high alert zone can notify other wireless devices, such as a vehicle and/or a static wireless device about its location and may warn the other wireless devices about its location in the zone to avoid a physical collision with a vehicle located in or approaching the same zone and/or subzone. Furthermore, if a wireless device is located in Zone C, the wireless device may be configured, such as may be scheduled, not to transmit SL-PRS signals (as the UE is located in safe zone). In one or more example methods, a vehicle may be allowed to, such as may be configured to and/or may be scheduled to, transmit SL-PRS continuously. However, the vehicle may in one or more example methods be configured to transmit SL-PRS more frequently in sub-zone A1 than in sub-zone B1.

In one or more example methods, a transmission condition may indicate that a WD (such as a non-static WD, such as a VRU) in a certain location and/or in a certain geographical area, such as in a zone and/or a sub-zone, can have a higher priority to transmit positioning measurement reports and/or warnings. For example, when a non-static WD is in a danger zone, it can be configured to transmit a positioning measurement report and/or a warning, so that a static WD, such as a RSU, and/or a Vehicle can receive information indicative of the non-static device being in the danger zone. This information may be used by the static-WD and/or the vehicle for physical collision avoidance, such as for avoiding a physical collision between the vehicle and the non-static WD.

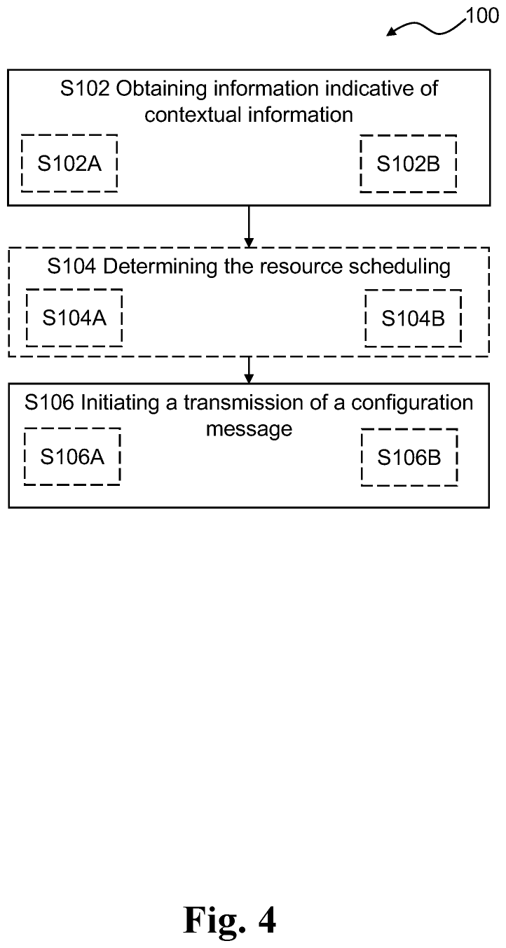

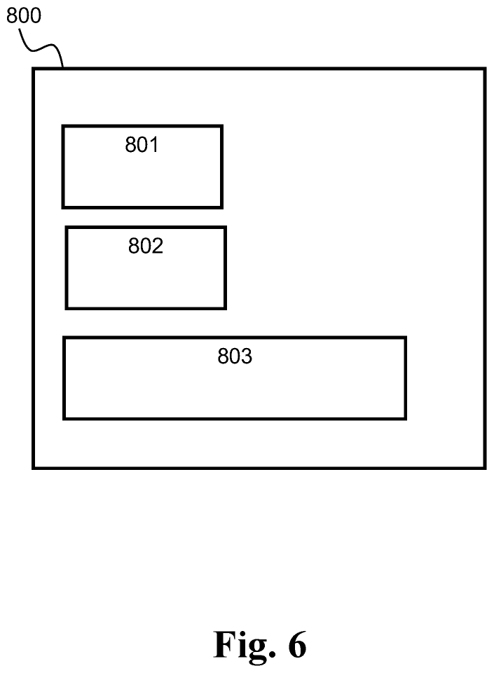

FIG. 4 shows a flow diagram of an example method 100, performed by a positioning network node according to the disclosure, for managing transmissions related to sidelink-positioning, such as positioning reference signal transmission, between a plurality of wireless devices. The positioning network node is a network node disclosed herein, such as a radio network node 400 and/or a core network node 600, such as a Location Management Function (LMF), of FIG. 1, FIG. 3, and/or the positioning network node 800 of FIG. 6.

The method 100 comprises obtaining S102 information indicative of contextual information relating to a geographical area being served by the positioning network node. The contextual information may be seen as a set of information associated with a geographical area, that may be advantageous and/or necessary, for determining a context of the geographical area. For example, the context may be indicative of a communication environment for wireless devices located in the geographical area, such as whether the geographical area is crowded or empty, and/or if there are many or a few wireless devices sharing the radio resources in the geographical area. In one or more example methods, the contextual information comprises a number of wireless devices in a predetermined geographical area. The number of wireless devices may be indicated as an actual number of wireless devices or may be implicitly indicated, such as for example whether there are many wireless devices, a few wireless devices, or no wireless devices in the geographical area. The predetermined geographical area may be one or more of a region, a zone and a sub-zone. The geographical areas may be predetermined by an operator of a service for providing collision avoidance or a network operator. In one or more example methods, the geographical areas may be predetermined based on for example geographical and/or demographical aspects. In one or more example methods, the contextual information comprises one or more types and/or groups of the wireless devices in the predetermined geographical area. The contextual information may for example indicate that there are one or more of a non-static wireless device, a static wireless device and a vehicle present in the predetermined geographical area. In one or more example methods, the contextual information comprises a distribution of the types and/or groups of wireless devices in the predetermined geographical area. The distribution of the types and/or groups of wireless devices may for example indicate a number of a certain type of and/or groups of wireless devices in a specific region, zone and/or sub-zone. In one or more example methods, the contextual information comprises a location of the wireless devices in the predetermined geographical area. The location may be in one or more example methods, be indicated as one or more of an actual position (such as a coordinate of the wireless device), a region, a zone and/or a subzone in which the wireless device is located. In one or more example methods, the contextual information comprises an identifier of the predetermined geographical area. In one or more example methods, the contextual information comprises environmental information associated with the predetermined geographical area. The environmental data may comprise one or more of a time of day, weather information, and temperature of the predetermined geographical area. In one or more example methods, such as when the positioning network node is a radio network node, such as a gNB, obtaining S102 comprises receiving S102A the information indicative of contextual information from one or more wireless devices located in the predetermined geographical area and being served by the radio network node. In one or more example methods, such as when the positioning network node is a core network node, such as the LMF, obtaining S102 comprises receiving S102 the information indicative of contextual information from one or more radio network nodes serving wireless devices located in the predetermined geographical area.

In one or more example methods, the method comprises determining S104, based on the obtained information, the resource scheduling for transmissions related to sidelink-positioning, such as sidelink positioning reference signal transmissions, transmission of positioning measurement reports and/or positioning estimates, between the plurality of wireless devices. In one or more example methods, determining S104 comprises determining resource scheduling for reception related to sidelink-positioning, such as the reception of sidelink positioning reference signal, reception of positioning measurement reports and/or positioning estimates, between the plurality of wireless devices. Positioning estimates may herein comprise warning related information, such as information indicating that a WD, such as a VRU or a vehicle, is nearby. In one or more example methods, determining S104 the resource scheduling comprises determining S104A, based on the obtained information, a respective resource scheduling for one or more contextual condition of a plurality of contextual conditions.

In one or more example methods, determining S104 comprises determining S104B, based on the obtained information, a transmission condition for transmissions related to sidelink-positioning, such as for transmitting a sidelink positioning reference signal. The transmission condition may be seen as a set of rules associated with the resource scheduling, that may indicate when a wireless device is allowed to use the scheduled resources for transmissions related to sidelink-positioning, such as for transmitting a sidelink positioning reference signal, in the geographical area. The transmission condition may be determined based on the contextual information. The resource scheduling and/or the transmission condition may be determined to reduce signalling related to sidelink positioning in the predetermined geographical area, to ensure that there are sufficient resources available for transmitting safety related messages, such as positioning measurement reports and/or a warning messages indicative of a non-static device being located in a danger zone, such as in an area where non-static wireless device is at risk of colliding with for example a vehicle. The resource scheduling and/or the transmission condition may thus be determined to ensure that there are available resources for transmitting information for physical collision avoidance, such as for avoiding a physical collision between the vehicle and the non-static WD.

In one or more example methods, the transmission condition is indicative of a type of wireless device and/or a group of wireless devices that the resource scheduling applies to. In one or more example methods, the transmission condition is indicative of a predetermined geographical area that the resource scheduling applies to. In one or more example methods, the transmission condition is indicative of an activation parameter indicative of when a wireless device and/or a group of wireless devices of the plurality of wireless devices is allowed to transmit transmissions related to sidelink-positioning, such as sidelink reference signals. The indication parameter may be indicative of when and when not a specific type of wireless device is allowed to transmit transmissions related to sidelink-positioning, such as sidelink positioning reference signal transmissions.

In one or more example methods, the group of wireless devices is grouped based on one or more of a wireless device identity, such as a UE ID, and/or a geographical location of the wireless device, such as based on a region ID, a zone ID and/or a sub-zone ID.

In one or more example methods, the type of wireless device comprises one or more of static wireless devices, non-static wireless devices, and moving vehicles. Static wireless devices herein mean devices that are arranged at a fixed location, such as RSUs. Non-static wireless devices herein mean devices that may move, such as wireless devices of pedestrians and/or cyclists, such as VRUs. Non-static wireless devices may be stationary or non-stationary, such as may move or may be still in one location, for periods of time. The non-static wireless devices may for example be non-stationary when the pedestrian is walking around and may be stationary when the pedestrian is standing still for a limited period of time, for example when waiting for a green light at a street crossing.

The configuration message may be broadcasted or transmitted using dedicated signaling to an individual wireless device and/or a group of wireless devices. In one or more example methods, the configuration message may comprise a plurality of resource schedulings, wherein each of the plurality of resource schedulings may be allocated to a respective set of wireless devices. The set of wireless devices may comprise one or more wireless devices, such as an individual wireless device or a group of wireless devices. Upon the configuration message comprising a plurality of resource schedulings, the configuration message may comprise one or more identifiers for identifying the set of wireless devices that each resource scheduling is associated with, such as allocated to. In one or more example methods, the configuration message may comprise a single resource scheduling, such as a dedicated resource scheduling for a dedicated set of wireless devices, such as for a dedicated wireless device and/or a dedicated group of wireless devices. The wireless devices may for example be grouped based on the type of wireless device, such as whether the wireless device is a non-static wireless device, a static wireless device or a vehicle. In one or more example methods, the configuration message comprises resource information for transmissions related to sidelink-positioning, such as sidelink transmission resource scheduling, for each type and/or group of wireless devices. In one or more example methods, a specific configuration message may be transmitted to each type and/or group of wireless device.

In one or more examples, a first configuration message comprising a first resource scheduling and/or a first transmission condition may be transmitted to a first type and/or group of wireless devices. In one or more example methods, the first configuration message may be transmitted to the non-static wireless devices. In one or more example methods, the first configuration message may be transmitted to non-static wireless devices in a first group, such as to non-static wireless devices in a specific geographical area, such as in a zone and/or in a subzone. In one or more examples, a second configuration message comprising a second resource scheduling and/or a second transmission condition may be transmitted to a second type and/or second group of wireless devices. In one or more example methods, the second configuration message may be transmitted to static wireless devices. In one or more example methods, the second configuration message may be transmitted to static wireless devices in a second group, such as to static wireless devices in a specific geographical area, such as in a zone and/or in a subzone. In one or more examples, a third configuration message comprising a third resource scheduling and/or a third transmission condition may be transmitted to a third type and/or third group of wireless devices. In one or more example methods, the third configuration message may be transmitted to vehicles. In one or more example methods, the third configuration message may be transmitted to vehicles in a second group, such as to vehicles in a specific geographical area, such as in a zone and/or in a subzone. In one or more example methods, one or more of the first resource scheduling, the second resource scheduling, the third resource scheduling, the first transmission condition, the second transmission condition, and the third transmission condition may be transmitted in a single configuration message. The single configuration message may comprise one or more identifier for associating the respective resource scheduling and/or transmission condition to the corresponding type and/or group of wireless devices.

In one or more example methods, the transmission conditions are provided in a priority order. Being provided in a priority order may herein be seen as being assigned a priority order indicating whether one transmission condition takes precedence over another transmission condition. Upon the configuration message comprising a plurality of transmission conditions, the plurality of transmission conditions may be provided in a priority order in the configuration message to indicate which transmission condition takes precedence over the other transmission conditions. For example, the configuration message may comprise a plurality of conditions in which one condition can have higher priority than the others. For example, according to a first condition a non-static WD located in sub-zone A2 can be configured to transmit SL-PRS more frequently than in sub-zone B2. However, according to a second condition, the non-static device may not be allowed to transmit SL-PRS in case the density of non-static wireless devices, such as the number of non-static wireless devices within a predetermined geographical area, is too high. In this case, the second condition may over-rule the first condition. The priority order may be implicitly or explicitly indicated. The priority order may be implicitly indicated by the order in which the transmission conditions are provided. For example, if the configuration message comprises a list of transmission conditions, the first condition in the list may be the transmission condition having the highest priority. The priority order may be explicitly indicated by the positioning network node telling the wireless device, for example by providing priority information to the wireless device, indicating that one of the transmission conditions has a higher priority than another transmission condition. For example, the priority information may explicitly indicate that for example a third transmission condition has higher priority than for example a first transmission condition in the list of transmission conditions.

In one or more example methods, the configuration message may comprise information identifying the predetermined geographical areas, such as zones and/or sub-zones. The information identifying the predetermined geographical area, may comprise one or more of a Zone ID identifying the zone, a sub-zone ID associated with the Zone ID and geographical information (such as coordinates) related to the zone and/or the sub-zone. In one or more example methods, the configuration message comprises one or more conditions, such as one or more transmission conditions, that are valid in a certain geographical area. The one or more conditions may for example be associated with specific Zone IDs and/or sub-zone IDs for which the condition is valid.

In one or more example methods, a first transmission condition indicates that, upon the number of non-static wireless devices in a first predetermined geographical area being equal to or above a first threshold, such as above the presence threshold, static wireless devices are to transmit transmissions related to sidelink-positioning, such as sidelink reference signals, more frequently than non-static wireless devices.

In one or more example methods, a second transmission condition indicates that, upon the number of non-static wireless devices in a first predetermined geographical area being equal to or above the first threshold, such as above the presence threshold, static wireless devices are to transmit transmissions related to sidelink-positioning, such as sidelink reference signal and non-static wireless devices are to refrain from transmitting transmissions related to sidelink-positioning, such as sidelink reference signals.

In one or more example methods, a third transmission condition indicates that, upon the number of non-static wireless devices in a first predetermined geographical area being below the first threshold, such as below the presence threshold, non-static wireless devices are to transmit transmissions related to sidelink-positioning, such as sidelink reference signal more frequently than static wireless devices.

In one or more example methods, a fourth transmission condition indicates that, upon the number of non-static wireless devices in a first predetermined geographical area being below the first threshold, such as below the presence threshold, non-static wireless devices are to transmit transmissions related to sidelink-positioning, such as sidelink reference signals, and static wireless devices are to refrain from transmitting transmissions related to sidelink-positioning, such as sidelink reference signals.

The transmission conditions mentioned herein, such as the first the second, the third, and the fourth transmission conditions, are example transmission conditions. The configuration message may comprise one or more of the example transmission conditions mentioned herein.

In one or more example methods, the configuration message may comprise the resource scheduling, such as time and frequency resources and a periodicity of the time and frequency resources, and information indicating whether then wireless device is allowed or not to transmit in a given time. The given time may be within a certain time period or until further notice.

The method 100 comprises initiating S106 a transmission of a configuration message for sidelink positioning reference signal transmission based on the obtained contextual information, the configuration message comprises one or more of the resource scheduling and a transmission condition for transmissions related to sidelink-positioning, such as for transmitting a sidelink positioning reference signal.

In one or more example methods, such as upon the positioning network node being a radio network node, initiating S106 the transmission comprises transmitting S106A the configuration message for transmissions related to sidelink-positioning, such as sidelink positioning reference signal transmission, based on the determined resource scheduling. The configuration message may comprise one or more of the determined resource scheduling and the transmission condition for transmitting a sidelink positioning reference signal according to the determined resource scheduling. In one or more example methods, the configuration message may comprise the transmission condition. The wireless devices may then determine, based on the transmission condition, whether the transmission condition is fulfilled. In one or more example methods, transmitting S106A comprises broadcasting the configuration message. In one or more example methods, transmitting S106A comprises transmitting the configuration message using dedicated signaling.

In one or more example methods, the positioning network node may determine whether the transmission condition is fulfilled. The configuration message may indicate whether one or more of the transmission conditions are fulfilled and/or may indicate to the wireless device to activate and/or deactivate SL-PRS transmissions according to the determined resource scheduling. This may for example be the case when the positioning network node is a radio network node and can keep track of the number of wireless devices in a certain area, such as in the predetermine geographical area.

In one or more example methods, such as upon the positioning network node being a core network node, such as an LMF, initiating S106 the transmission comprises instructing S106B a radio network node to transmit the configuration message. The core network node, such as the LMF, may instruct the radio network node to update the resource scheduling and/or transmission conditions for transmissions related to sidelink-positioning, such as for SL-PRS transmission, and to transmit the configuration message.

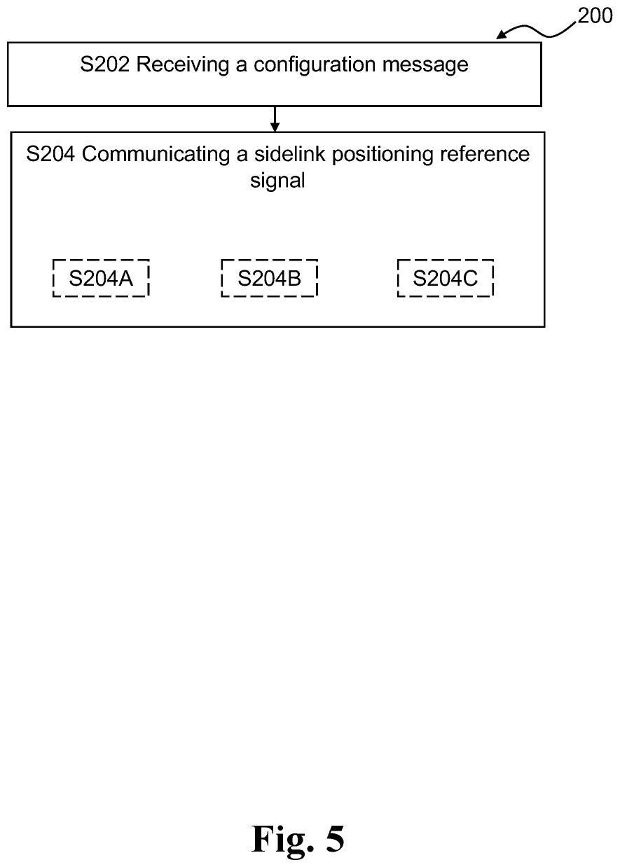

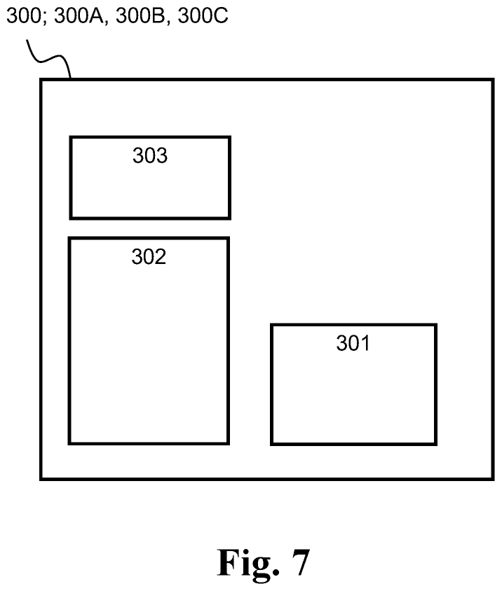

FIG. 5 shows a flow diagram of an example method 200, performed by a wireless device according to the disclosure, for managing side-link communication between a plurality of WDs. The wireless device is the wireless device disclosed herein, such as wireless device 300A, 300B and/or 3000 of FIG. 1, FIG. 2A, FIG. 2B, FIG. 3 and FIG. 7.

The method 200 comprises receiving S202, from a network node, a configuration message. The configuration message comprises a resource scheduling for transmitting transmissions related to sidelink-positioning, such as SL-PRS and/or a transmission condition for transmitting transmissions related to sidelink-positioning, such as SL-PRS according to the resource scheduling. The configuration message received by the wireless device in step S202 corresponds to the configuration message initiated to be transmitted by the positioning network node in step S106.

In one or more example methods, the transmission condition is indicative of a type of wireless device and/or a group of wireless devices that the resource scheduling applies to. In one or more example methods, the transmission condition is indicative of a predetermined geographical area that the resource scheduling applies to. In one or more example methods, the transmission condition is indicative of an activation parameter indicative of when a wireless device and/or a group of wireless devices of the plurality of wireless devices is allowed to transmit signals related to sidelink positioning, such as sidelink reference signals.

In one or more example methods, the configuration message may comprise information identifying the predetermined geographical areas, such as zones and/or sub-zones. The information identifying the predetermined geographical area, may comprise one or more of a Zone ID identifying the zone, a sub-zone ID associated with the Zone ID and geographical information (such as coordinates) related to the zone and/or the sub-zone. In one or more example methods, the configuration message comprises conditions that are valid in a certain geographical area. The conditions may for example be associated with specific Zone IDs and/or sub-zone IDs for which the condition is valid.

In one or more example methods, the group of wireless devices is grouped based on one or more of a wireless device identity and a geographical location of the wireless device.

In one or more example methods, wherein the type of wireless device comprises one or more of static wireless devices, non-static wireless devices, and moving vehicles.

In one or more example methods, the configuration message comprises specific resources for transmissions related to sidelink-positioning, such as a sidelink transmission for each of the types of wireless devices.

In one or more example methods, a first transmission condition indicates that, upon the number of non-static wireless devices in a first predetermined geographical area being equal to or above a first threshold, static wireless devices are to transmit signals related to sidelink-positioning, such as sidelink reference signals, more frequently than non-static wireless devices.

In one or more example methods, a second transmission condition indicates that, upon the number of non-static wireless devices in a first predetermined geographical area being equal to or above a first threshold, static wireless devices are to transmit signals related to sidelink-positioning, such as a sidelink reference signal and non-static wireless devices are to refrain from transmitting signals related to sidelink-positioning, such as sidelink reference signals.

In one or more example methods, a third transmission condition indicates that, upon the number of non-static wireless devices in a first predetermined geographical area being below a first threshold, non-static wireless devices are to transmit signals related to sidelink-positioning, such as sidelink reference signal more frequently than static wireless devices.

In one or more example methods, a fourth transmission condition indicates that, upon the number of non-static wireless devices in a first predetermined geographical area being below a first threshold, non-static wireless devices are to transmit signals related to sidelink-positioning, such as sidelink reference signals and static wireless devices are to refrain from transmitting signals related to sidelink-positioning, such as sidelink reference signals.

The method 200 comprises communicating S204, based on the received configuration message, a signal related to sidelink-positioning, such as a sidelink positioning reference signal in sidelink.

In one or more example methods, communicating S204 comprises determining S204A whether the transmission condition is fulfilled. In one or more example methods, communicating S204 comprises, upon the transmission condition being fulfilled, transmitting S204B the signal related to sidelink-positioning, such as the sidelink positioning reference signal, according to the resource scheduling. In one or more example methods, the configuration message may comprise the transmission condition. The wireless devices may then determine, based on the transmission condition, whether the transmission condition is fulfilled. In case the wireless device is in Idle Mode, such as in a Radio Resource Control (RRC) Idle Mode, the radio network node may not be aware of the wireless device being located in a cell of the radio network node, in this case the radio network node cannot determine whether the transmission condition is fulfilled for the wireless device. A wireless device being in Idle Mode may thus have to determine whether the transmission condition is fulfilled on its own.

In one or more example methods, a transmission condition may indicate that, upon the transmission condition not being fulfilled, the wireless device is to monitor for SL-PRS according to the received resource scheduling.

In one or more example methods, the positioning network node may determine whether the transmission condition is fulfilled. The configuration message may thus indicate whether one or more of the transmission conditions are fulfilled and/or may indicate to the wireless device to activate and/or deactivate SL-PRS transmissions according to the determined resource scheduling. This may for example be the case when the positioning network node is a radio network node and can keep track of the number of wireless devices in a certain area, such as in the predetermine geographical area.

In one or more example methods, communicating S204 comprises, upon the transmission condition not being fulfilled, monitoring S204C SL-PRS according to the resource scheduling. In one or more example methods, monitoring S204C SL-PRS comprises receiving SL-PRS from a second wireless device and performing measurement, such as positioning measurements, based on the received sidelink positioning reference signal. The wireless device may thus, upon the transmission condition not being fulfilled, monitor SL-PRS according to the resource scheduling to determine its own position.

FIG. 6 shows a block diagram of an example positioning network node 800 according to the disclosure. The positioning network node 800 comprises memory circuitry 801, processor circuitry 802, and a wireless interface 803. The positioning network node 800 may be configured to perform any of the methods disclosed in FIG. 5. In other words, the positioning network node 800 may be configured for managing positioning reference signal transmission between a plurality of wireless devices. The positioning network node may be a network node configured to position one or more wireless devices. The positioning network node 800 may be a radio network node, such as the radio network node 400 of FIG. 1, or a positioning function in a core network node, such as in the core network node 600 of FIG. 1.

The positioning network node 800 is configured to communicate with a user equipment, such as the user equipment node disclosed herein, using a wireless communication system.

The wireless interface 803 is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M. The wireless interface 303 is configured for wireless communications via one or more frequency range(s), for example, millimeter-wave communications. The wireless interface 303 is configured for wireless communications via various frequency allocation types, such as licensed bands and/or unlicensed bands.

The positioning network node 800 is configured to obtain information indicative of contextual information relating to a geographical area being served by the positioning network node.

The positioning network node 800 is configured to initiate a transmission of a configuration message for sidelink positioning reference signal transmission based on the obtained contextual information, wherein the configuration message comprises a resource scheduling and a transmission condition for transmitting a sidelink positioning reference signal.

Processor circuitry 802 is optionally configured to perform any of the operations disclosed in FIG. 4 (such as any one or more of S102, S104, S104A, S104B, S106, S106A, S106B). The operations of the positioning network node 800 may be embodied in the form of executable logic routines (for example, lines of code, software programs, etc.) that are stored on a non-transitory computer readable medium (for example, memory circuitry 801) and are executed by processor circuitry 802).

Furthermore, the operations of the positioning network node 800 may be considered a method that the positioning network node 800 is configured to carry out. Also, while the described functions and operations may be implemented in software, such functionality may also be carried out via dedicated hardware or firmware, or some combination of hardware, firmware and/or software.

Memory circuitry 801 may be one or more of a buffer, a flash memory, a hard drive, a removable media, a volatile memory, a non-volatile memory, a random access memory (RAM), or other suitable device. In a typical arrangement, memory circuitry 801 may include a non-volatile memory for long term data storage and a volatile memory that functions as system memory for processor circuitry 802. Memory circuitry 801 may exchange data with processor circuitry 802 over a data bus. Control lines and an address bus between memory circuitry 801 and processor circuitry 802 also may be present (not shown in FIG. 6). Memory circuitry 801 is considered a non-transitory computer readable medium.

Memory circuitry 801 may be configured to store information, such as contextual information, resource scheduling, and/or transmission conditions in a part of the memory.

FIG. 7 shows a block diagram of an example wireless device 300 according to the disclosure. The wireless device 300 comprises memory circuitry 301, processor circuitry 302, and a wireless interface 303. The wireless device 300 may be configured to perform any of the methods disclosed in FIG. 5. In other words, the wireless device 300 may be configured for managing side-link communication between a plurality of WDs.

The wireless device 300 is configured to communicate with a network node, such as the positioning network node disclosed herein, using a wireless communication system.

The wireless interface 303 is configured for wireless communications via a wireless communication system, such as a 3GPP system, such as a 3GPP system supporting one or more of: New Radio, NR, Narrow-band IoT, NB-IoT, Long Term Evolution-enhanced, LTE, and LTE Machine Type Communication, LTE-M. The wireless interface 303 is configured for wireless communications via one or more frequency range(s), for example, millimeter-wave communications. The wireless interface 303 is configured for wireless communications via various frequency allocation types, such as licensed bands and/or unlicensed bands.

The wireless device 300 is configured to receive from a positioning network node, a configuration message, the configuration message comprising a resource scheduling for transmitting SL-PRS and/or a transmission condition for transmitting SL-PRS according to the resource scheduling.

The wireless device 300 is configured to communicate based on the received configuration message, a sidelink positioning reference signal in sidelink.

The wireless device 300 is optionally configured to perform any of the operations disclosed in FIG. 5 (such as any one or more of (S202, S204, S204A, S204B, S204C). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store information, such as contextual information, resource scheduling, and/or transmission conditions in a part of the memory.

Examples of methods and products (network node and wireless device) according to the disclosure are set out in the following items:
Item 1. A method performed by a positioning network node, for managing positioning reference signal transmission between a plurality of wireless devices, the method comprising:
   obtaining (S102) information indicative of contextual information relating to a geographical area being served by the positioning network node,
   initiating (S106) a transmission of a configuration message for sidelink positioning reference signal transmission based on the obtained contextual information, wherein the configuration message comprises one or more of a resource scheduling and a transmission condition for transmitting a sidelink positioning reference signal.
Item 2. The method according to Item 1, wherein the method comprises:
   determining (S104), based on the obtained information, the resource scheduling for sidelink positioning reference signal transmission between the plurality of wireless devices.
Item 3. The method according to Item 2, wherein the method comprises:
   transmitting (S106A) the configuration message for sidelink positioning reference signal transmission based on the determined resource scheduling, wherein the configuration message comprises one or more of the determined resource scheduling and the transmission condition for transmitting a sidelink positioning reference signal according to the determined resource scheduling.
Item 4. The method according to any one of the Items 1 to 3, wherein the transmission condition is indicative of one or more of:
   a type of wireless device and/or a group of wireless devices that the resource scheduling applies to,
   a predetermined geographical area that the resource scheduling applies to, and
   an activation parameter indicative of when a wireless device and/or a group of wireless devices of the plurality of wireless devices is allowed to transmit sidelink reference signals.
Item 5. The method according to Item 4 wherein the group of wireless devices is grouped based on one or more of a wireless device identity and a geographical location of the wireless device.
Item 6. The method according to Item 4 or 5, wherein the type of wireless device comprises one or more of static wireless devices, non-static wireless devices, and moving vehicles.
Item 7. The method according to Item 6, wherein the configuration message is specific and/or comprises specific resources for sidelink transmission for each type of wireless devices.
Item 8. The method according to any of the previous Items, wherein the transmission conditions are provided in a priority order.
Item 9. The method according to any one of the previous Items, wherein a first transmission condition indicates that, upon the number of non-static wireless devices in a first predetermined geographical area being equal to or above a first threshold, static wireless devices are to transmit sidelink reference signals more frequently than non-static wireless devices.
Item 10. The method according to any one of the previous Items, wherein a second transmission condition indicates that, upon the number of non-static wireless devices in a first predetermined geographical area being equal to or above a first threshold, static wireless devices are to transmit sidelink reference signal and non-static wireless devices are to refrain from transmitting sidelink reference signals.
Item 11. The method according to any one of the previous Items, wherein a third transmission condition indicates that, upon the number of non-static wireless devices in a first predetermined geographical area being below a first threshold, non-static wireless devices are to transmit sidelink reference signal more frequently than static wireless devices.
Item 12. The method according to any one of the previous Items, wherein a fourth transmission condition indicates that, upon the number of non-static wireless devices in a first predetermined geographical area being below a first threshold, non-static wireless devices are to transmit sidelink reference signal and static wireless devices are to refrain from transmitting sidelink reference signals.
Item 13. The method according to any one of the previous Items, wherein the contextual information comprises one or more of:
   a number of wireless devices in a predetermined geographical area,
   one or more types and/or groups of the wireless devices in the predetermined geographical area,
   a distribution of the types and/or groups of wireless devices in the predetermined geographical area,
   a location of the wireless devices in the predetermined geographical area,
   an identifier of the predetermined geographical area, and
   environmental information associated with the predetermined geographical area.
Item 14. The method according to Item 13, wherein determining (S104) the resource scheduling comprises determining (S104A), based on the obtained information, a respective resource scheduling for one or more contextual condition of a plurality of contextual conditions.
Item 15. The method according to any one of the previous Items, wherein initiating (S106) the transmission comprises one or more of:
   transmitting (S106A) the configuration message, and
   instructing (S106B) a radio network node to transmit the configuration message.
Item 16. A method performed by a wireless device, for managing side-link communication between a plurality of WDs, the method comprising:
   receiving (S202), from a network node, a configuration message, the configuration message comprising a resource scheduling for transmitting sidelink positioning reference signals and a transmission condition for transmitting sidelink positioning reference signals according to the resource scheduling, and
   communicating (S204), based on the received configuration message, a sidelink positioning reference signal in sidelink.
Item 17. The method according to Item 16, wherein communicating (S204) comprises:
   determining (S204A) whether the transmission condition is fulfilled,
   upon the transmission condition being fulfilled, transmitting (S204B) a sidelink positioning reference signal according to the resource scheduling.
Item 18. The method according to Item 17, wherein communicating (S204) comprises:
   upon the transmission condition not being fulfilled, monitoring (S204C) sidelink positioning reference signals according to the resource scheduling.
Item 19. The method according to Item 17 or 18, wherein the transmission condition is indicative of one or more of:
   a type of wireless device and/or a group of wireless devices that the resource scheduling applies to,
   a predetermined geographical area that the resource scheduling applies to, and
   an activation parameter indicative of when a wireless device and/or a group of wireless devices of the plurality of wireless devices is allowed to transmit sidelink reference signals.
Item 20. The method according to Item 19, wherein the group of wireless devices is grouped based on one or more of a wireless device identity and a geographical location of the wireless device.
Item 21. The method according to Item 19 or 20, wherein the type of wireless device comprises one or more of static wireless devices, non-static wireless devices, and moving vehicles.
Item 22. The method according to Item 21, wherein the configuration message comprises specific resources for sidelink transmission for each of the types of wireless devices.
Item 23. A positioning network node comprising memory circuitry, processor circuitry, and a wireless interface, wherein the positioning network node is configured to perform any of the methods according to any of Items 1-15.
Item 24. A wireless device comprising memory circuitry, processor circuitry, and a wireless interface, wherein the wireless device is configured to perform any of the methods according to any of Items 16-22.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-7 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a positioning network node, for managing positioning reference signal transmission between a plurality of wireless devices, the method comprising:
obtaining information indicative of contextual information relating to a geographical area being served by the positioning network node,
initiating a transmission of a configuration message for sidelink positioning reference signal transmission based on the obtained contextual information, wherein the configuration message comprises one or more of a resource scheduling and a transmission condition for transmitting a sidelink positioning reference signal.

2. The method according to claim 1, wherein the method comprises:
determining, based on the obtained information, the resource scheduling for sidelink positioning reference signal transmission between the plurality of wireless devices.

3. The method according to claim 2, wherein the method comprises:
transmitting the configuration message for sidelink positioning reference signal transmission based on the determined resource scheduling, wherein the configuration message comprises one or more of the determined resource scheduling and the transmission condition for transmitting a sidelink positioning reference signal according to the determined resource scheduling.

4. The method according to claim 1, wherein the transmission condition is indicative of one or more of:
a type of wireless device and/or a group of wireless devices that the resource scheduling applies to,
a predetermined geographical area that the resource scheduling applies to, and
an activation parameter indicative of when a wireless device and/or a group of wireless devices of the plurality of wireless devices is allowed to transmit sidelink reference signals.

5. The method according to claim 4 wherein the group of wireless devices is grouped based on one or more of a wireless device identity and a geographical location of the wireless device.

6. The method according to claim 4, wherein the type of wireless device comprises one or more of static wireless devices, non-static wireless devices, and moving vehicles.

7. The method according to claim 6, wherein the configuration message is specific and/or comprises specific resources for sidelink transmission for each type of wireless devices.

8. The method according to claim 1, wherein the transmission conditions are provided in a priority order.

9. The method according to claim 1, wherein a first transmission condition indicates that, upon the number of non-static wireless devices in a first predetermined geographical area being equal to or above a first threshold, static wireless devices are to transmit sidelink reference signals more frequently than nonstatic wireless devices.

10. The method according to claim 1, wherein a second transmission condition indicates that, upon the number of non-static wireless devices in a first predetermined geographical area being equal to or above a first threshold, static wireless devices are to transmit sidelink reference signal and non-static wireless devices are to refrain from transmitting sidelink reference signals.

11. The method according to claim 1, wherein a third transmission condition indicates that, upon the number of non-static wireless devices in a first predetermined geographical area being below a first threshold, non-static wireless devices are to transmit sidelink reference signal more frequently than static wireless devices.

12. The method according to claim 1, wherein a fourth transmission condition indicates that, upon the number of non-static wireless devices in a first predetermined geographical area being below a first threshold, non-static wireless devices are to transmit sidelink reference signal and static wireless devices are to refrain from transmitting sidelink reference signals.

13. The method according to claim 1, wherein the contextual information comprises one or more of:
a number of wireless devices in a predetermined geographical area,
one or more types and/or groups of the wireless devices in the predetermined geographical area,
a distribution of the types and/or groups of wireless devices in the predetermined geographical area,
a location of the wireless devices in the predetermined geographical area,
an identifier of the predetermined geographical area, and
environmental information associated with the predetermined geographical area.

14. The method according to claim 13, wherein determining the resource scheduling comprises determining, based on the obtained information, a respective resource scheduling for one or more contextual condition of a plurality of contextual conditions.

15. The method according to claim 1, wherein initiating the transmission comprises one or more of:
transmitting the configuration message, and
instructing a radio network node to transmit the configuration message.

16. A method performed by a wireless device, for managing side-link communication between a plurality of wireless devices (WDs), the method comprising:
receiving, from a network node, a configuration message, the configuration message comprising a resource scheduling for transmitting sidelink positioning reference signals and a transmission condition for transmitting sidelink positioning reference signals according to the resource scheduling, and
communicating, based on the received configuration message, a sidelink positioning reference signal in sidelink.

17. The method according to claim 16, wherein communicating comprises:
determining whether the transmission condition is fulfilled,
upon the transmission condition being fulfilled, transmitting a sidelink positioning reference signal according to the resource scheduling.

18. The method according to claim 17, wherein communicating comprises:
upon the transmission condition not being fulfilled, monitoring sidelink positioning reference signals according to the resource scheduling.

19. The method according to claim 17, wherein the transmission condition is indicative of one or more of:
a type of wireless device and/or a group of wireless devices that the resource scheduling applies to,
a predetermined geographical area that the resource scheduling applies to, and
an activation parameter indicative of when a wireless device and/or a group of wireless devices of the plurality of wireless devices is allowed to transmit sidelink reference signals.

20. The method according to claim 19, wherein the group of wireless devices is grouped based on one or more of a wireless device identity and a geographical location of the wireless device.

21-24. (canceled)
